(19) United States
(12) Patent Application Publication
(10) Pub. No.: US 2006/0290612 A1
(43) Pub. Date: Dec. 28, 2006

(54) Current sample-and-hold circuit and display device including the same

(75) Inventors: Yong Min Ha, Gyeongsangbuk-do (KR); Chang Hwan Lee, Gyeongsangbuk-do (KR); In Gyo Seo, Daegu (KR)

Correspondence Address: JENKENS & GILCHRIST, P.C., 901 15TH STREET N.W., SUITE 900, WASHINGTON, DC, 20005, US

(73) Assignee: Royal Patent Law Office, Seoul (KR)

(21) Appl. No.: 11/297,341

(22) Filed: Dec. 9, 2005

(30) Foreign Application Priority Data
Jun. 27, 2005 (KR) 10-2005-0055572

(51) Int. Cl. G09G 3/30

(52) U.S. Cl. 345/76

(57) ABSTRACT

A current sample-and-hold circuit of the present invention includes a storage capacitor for storing an initial image-signal current, a first transistor for receiving one of an initial image-signal current from a voltage power supply and an input image-signal current from a pixel circuit, a second transistor for connecting between the first thin film transistor and a first ground, a third transistor and a fourth transistor for biasing the gates of the first and second transistors to sample and hold the initial image-signal current using a second ground in response to a control signal and sinking the input image-signal current from a pixel circuit to the first ground in response to receiving the input image-signal current from the pixel circuit.

The present invention claims the benefit of Korean Patent Application No. 10-2005-0055572 filed in Korea on Jun. 27, 2005, which is hereby incorporated by reference in its entirety.

### BACKGROUND OF THE INVENTION

1. Field of the Invention

The present invention relates to circuitry, and more particularly to a current sample-and-hold circuit that samples and holds an initial image-signal current. Although the present invention is suitable for a wide scope of applications, it is particularly suitable for simplifying a circuit structure.

2. Discussion of the Related Art

In general, an organic light-emitting diode is an active light-emitting element that emits light by recombination of electrons and holes. Organic light-emitting display devices, including an organic light-emitting diode, are used in wall mounted electronic devices or portable type electronic devices. Organic light-emitting display devices have a fast response time, low direct-current driving voltage, and a slim profile, in comparison with a passive light-emitting device, such as a liquid crystal display, which needs a separate light source.

An organic light-emitting display (OLED) emits different types of colors using pixels. Each of the pixels include red, green and blue sub-pixels that are used together to emit a color. Thus, all of the pixels can be used together to display a picture.

The OLED can be classified according to its driving method, such as passive-matrix type OLED (PMOLED) and an active-matrix OLED (AMOLED), which uses thin film transistors (TFT) in each sub-pixel. The AMOLED driving method is sub-classified into a current driving method, a voltage driving method and a digital driving method. The current driving method is further divided into a current-source type driving method and a current-sink type driving method. The current sink type AMOLED typically includes a sample-and-hold circuit that samples and holds an initial image signal current, and sinks an input image-signal current to a data line of an OLED.

FIG. 1 is a circuit diagram illustrating a related art sample-and-hold circuit. Referring to FIG. 1, a related art sample-and-hold circuit 10 is connected to a sub-pixel circuit 14, including first, second, third and fourth TFTs P1 to P4 and two capacitors Cₛₜ and C_{boost} via two data lines 12. The first to fourth TFTs P1 to P4 are p-channel metal oxide semiconductor (PMOS) TFTs. The pixel circuit 14 further includes first, second and third scan lines for respectively supplying the select scan signal “select_{[m]},” the boost scan signal “boost_{[m]},” and the emission scan signal “emit_{[m]}.” Although FIG. 1 only shows one sample-and-hold circuit 10, one data line 12, and one sub-pixel circuit 14, a typical OLED includes a plurality of sample-and-hold circuits connected to a plurality of sub-pixels via the data lines. FIG. 1 is a simplified circuit diagram for explanation purposes herein.

The related art sample-and-hold circuit 10 includes six transistors and a capacitor C_{hold}. Among the six transistors, the first transistor M1, the second transistor M2, the fourth transistor M4, the fifth transistor M5 and the sixth transistor M6 are p-channel metal oxide semiconductor (PMOS) transistors, and the third transistor M3 is an n-channel metal oxide semiconductor (NMOS) transistor. A sample/hold signal “A” can be simultaneously applied to the gates of the second, fourth, fifth transistors M2, M4 and M5, and a store signal “B” can be applied simultaneously to the gates of the third and sixth transistors M3 and M6.

The source of the second transistor M2 is connected to a voltage power supply VDD and the drain of the second transistor M2 is connected to the capacitor C_{hold} and the drain of the sixth transistor M6. The source of the sixth transistor M6 is connected to the data line 12 and the drain of the sixth transistor M6 is connected to both the drain of the second transistor M2 and the capacitor C_{hold}. The drain of the first transistor M1 is connected to the source of the third transistor M3 and the source of the fifth transistor M5. The gate of the first transistor M1 is connected to the capacitor C_{hold} and the source of the fourth transistor M4. The drain of the third transistor M3 is connected to the ground voltage VSS2, and the drains of the fourth and fifth transistors M4 and M5 are connected to a ground voltage VSS1 through a current source.

FIG. 2 is a diagram illustrating signal waveforms used in the related art current sample-and-hold circuit shown in FIG. 1. The operation of the related art current sample-and-hold circuit 10 will be described in reference to both FIG. 1 and FIG. 2. When the sample/hold signal “A” is applied to the related art current sample-and-hold circuit, the first, second and fifth transistors M1, M2 and M5 are turned on, and an initial image-signal current “I_{data1}” flows from the voltage power supply VDD1 through the first, second and fifth transistors M1, M2 and M5, so that the initial image-signal current “I_{data1}” is sampled and held in the capacitor C_{hold}.

If the sample/hold signal “A” is applied so that the input image-signal current “I_{data1}” is sampled and held in the storage capacitor C_{hold}, and then sequentially the store signal “B” and the select scan signal “select_{[m]}” are applied to the current sample-and-hold circuit 10 and the pixel circuit 14, respectively, an input image-signal current “I_{data2}” flows from the pixel circuit 14, passing through the data line 12 and the sixth, first and fifth transistors of the current sample-and-hold circuit 10. As the input image-signal current “I_{data2}” flows, data is stored into the storage capacitor Cₛₜ of the pixel circuit 14. The data stored in the storage capacitor Cₛₜ can provide a driving current “I_{oled}” to the organic light-emitting diode when the emit scan signal “emit_{[m]}” is applied to the fourth TFT P4 of the pixel circuit 14, so that light is emitted from the organic light-emitting diode.

The third transistor M3 is required in the related art current sample-and-hold circuit 10 to prevent the initial image-signal current “I_{data1}” from flowing to the VSS2 when sampling and holding the initial image-signal current “I_{data1}” is charging the capacitor C_{hold}. While the third transistor M3 is turned off, the initial image-signal current “I_{data1}” can be sampled and charged into the capacitor C_{hold}. The sixth transistor M6 is turned on by the store signal “B” so that the current sample-and-hold circuit 10 is then connected to the data line 12 by the sixth transistor M6.

The related art OLED has a drawback in that a large number of pins are required on the current sample-and-hold circuits for connecting to each of the driving signal lines, such as the sample/hold and store signal lines, of the current sample-and-hold circuits in an OLED. The large number of pins for connecting the driving signal leads to the current sample-and-hold circuits increases the manufacturing costs of the OLED. Such a problem associated with the number of pins in an OLED for connecting driving signal leads to the current sample-and-hold circuits is even more serious in high resolution OLEDs, which require a larger number of current sample-and-hold circuits.

### SUMMARY OF THE INVENTION

Accordingly, the present invention is directed to a current sample-and-hold circuit and display device including the same that substantially obviates one or more of the problems due to limitations and disadvantages of the related art.

An object of the present invention is to provide a current sample-and-hold circuit having a reduced number of signal leads.

Another object of the present invention is to provide a current sample-and-hold circuit having a reduced number of pins.

Additional features and advantages of the invention will be set forth in the description which follows, and in part will be apparent from the description, or may be learned by practices of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a current sample-and-hold circuit according to the present invention includes a current sample-and-hold circuit includes a storage capacitor for storing an initial image-signal current, a first transistor for receiving one of an initial image-signal current from a voltage power supply and an input image-signal current from a pixel circuit, a second transistor for connecting between the first thin film transistor and a first ground, a third transistor and a fourth transistor for biasing the gates of the first and second transistors to sample and hold the initial image-signal current using a second ground in response to a control signal and sinking the input image-signal current from a pixel circuit to the first ground in response to receiving the input image-signal current from the pixel circuit.

In another aspect of the present invention, there is provided a current sample-and-hold circuit including a storage capacitor for storing an initial image-signal current, a first transistor has a source for receiving one of an initial image-signal current from a voltage power supply and an input image-signal current from a pixel circuit, the source of the first transistor connected to a first electrode of the storage capacitor and a gate of the first transistor connected to a second electrode of the capacitor, a second transistor is connected between the first thin film transistor and a first ground for sinking the input image-signal current from a pixel circuit to the first ground, a gate of the second transistor is connected to the gate of the first transistor, a third transistor and a fourth transistor for biasing the gates of the first and second transistors such that a first conduction path between the drain of the first transistor and a second ground through a current source occurs for sampling and holding an initial image-signal current in response to a control signal and a second conduction path between the drain of the first transistor and a first ground through the second transistor occurs in response to a source of the first transistor receiving the input image-signal current from the pixel circuit ,and a fifth transistor for connecting the source of the first transistor to a voltage power supply in response to the control signal.

In yet another aspect of the present invention, a display device includes a pixel circuit positioned at the intersection of a data line and a scan line, and a current sample-and-hold circuit connected to a voltage power supply, a first ground, a second ground and to the pixel circuit via a data line, the current sample-and-hold circuit including switching means for creating a first conduction path between the voltage power supply and the second ground through a current source to sample and hold an initial image-signal current in response to a control signal and for creating a second conduction path between data line and a first ground through the second transistor in response to receiving an input image-signal current from the pixel circuit via the data line.

It is to be understood that both the foregoing general description and the following detailed description are exemplary and explanatory and are intended to provide further explanation of the invention as claimed.

### BRIEF DESCRIPTION OF THE DRAWINGS

The invention will be described in detail with reference to the following drawings in which like numerals refer to like elements.

FIG. 1 is a circuit diagram illustrating a related art current sample-and-hold circuit used in an organic light-emitting display device;

FIG. 2 is a diagram illustrating signal waveforms used in the related art current sample-and-hold circuit shown in FIG. 1;

FIG. 3 is a circuit diagram illustrating a current sample-and-hold circuit used in an OLED, according to a first embodiment of the present invention;

FIG. 4 is a diagram illustrating signal waveforms used in the current sample-and-hold circuit shown in FIG. 3;

FIGS. 5a and 5b are circuit diagrams illustrating respective driving statuses of the current sample-and-hold circuit shown in FIG. 3, which is driven using the signal waveforms shown in FIG. 4;

FIG. 6 is a circuit diagram illustrating a current sample-and-hold circuit according to a second embodiment of the present invention; and

FIG. 7 is a circuit diagram illustrating a current sample-and-hold circuit according to a third embodiment of the present invention.

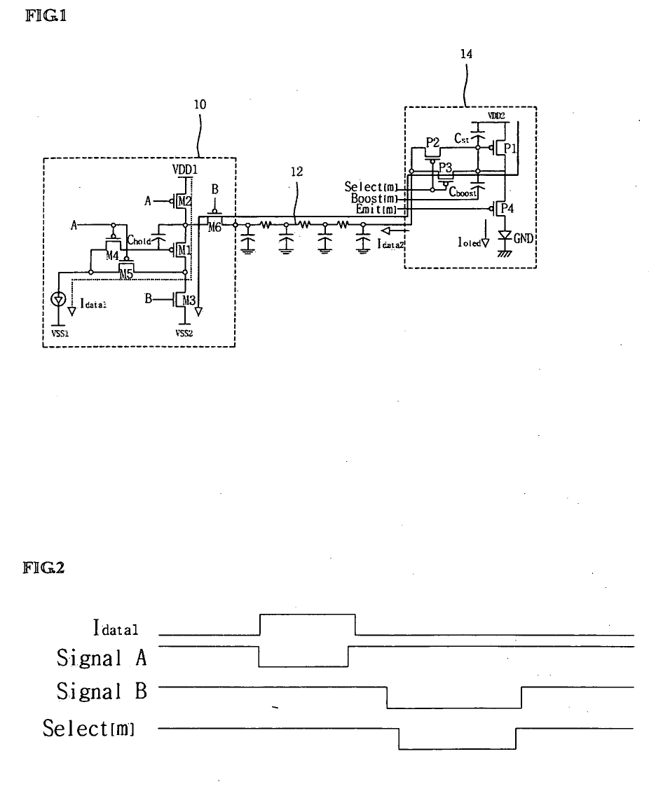

### DETAILED DESCRIPTION OF THE PREFERRED EMBODIMENTS

Preferred embodiments of the present invention will be described in a more detailed manner with reference to the drawings.

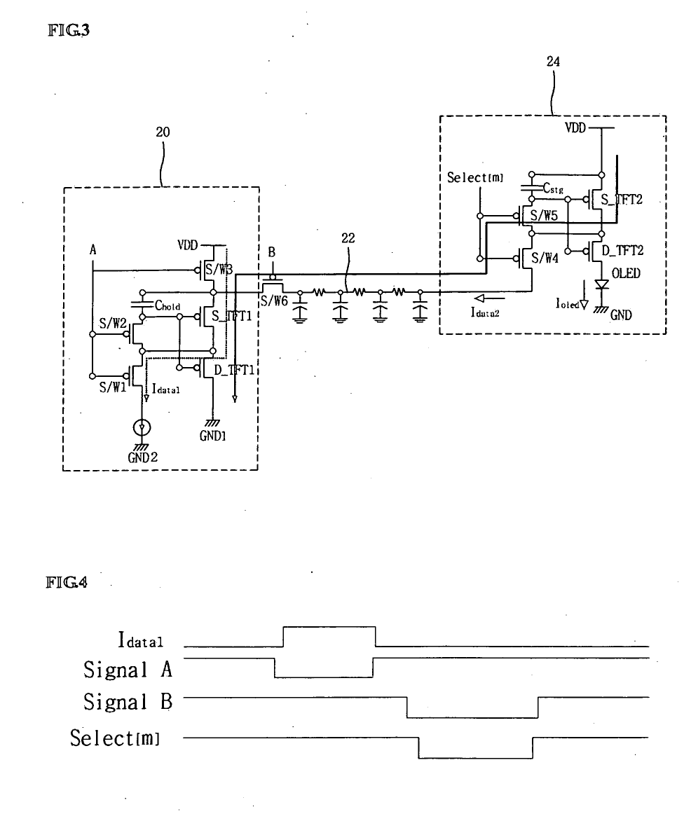

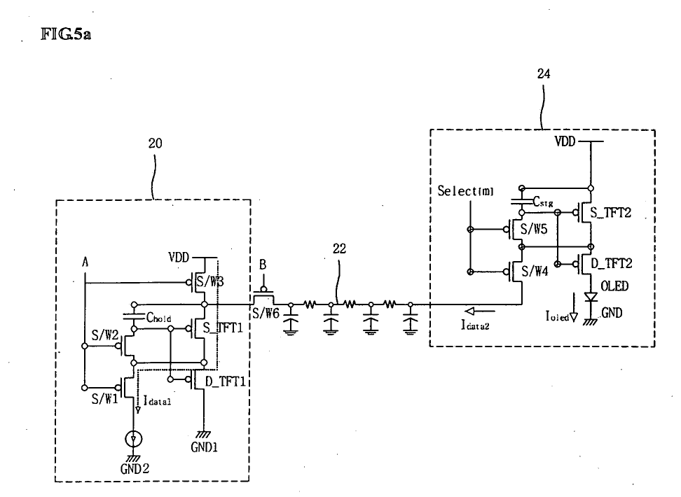

FIG. 3 is a circuit diagram illustrating a current sample-and-hold circuit according to a first embodiment of the present invention. As shown in FIG. 3, the current sample-and-hold circuit 20 sinks an input image-signal current from a data line 22 of a current-sink type AMOLED 24 to a first ground GND1 and, samples and holds an initial image-signal current using a second GND2. FIG. 4 is a diagram illustrating signal waveforms used in the current sample-and-hold circuit shown in FIG. 3.

Referring back to FIG. 3, a current sample-and-hold circuit 20 according to a first embodiment of the present invention is connected to a pixel circuit 24 via a data line 22. The pixel circuit 24 includes first, second, third and fourth p-channel MOS TFTs S_TFT2, D_TFT2, S/W4 and S/W5 and a capacitor C_{sgs}. Further, a scan line for the select scan signal “select(m)” is connected to gates of the respective third and fourth p-channel TFTs S/W4 and SW/5. Although FIG. 3 illustrates only one current sample-and-hold circuit 20, one data line 22 and one pixel circuit 24, an OLED according to embodiments of the present invention includes a plurality of current sample-and-hold circuits connected to a plurality of pixel circuits via data lines.

The current sample-and-hold circuit 20 includes a first transistor S-TFT1, a second transistor D_TFT1, a third transistor S/W1, a fourth transistor S/W2, a fifth transistor S/W3 and a capacitor C_{hold}. The first, second, third, fourth and fifth transistor can be p-channel TFTs. In general, third and fourth transistors S/W1 and S/W2 bias the gates of the first and second transistors S-TFT1 and D_TFT1 such that a conduction path between the drain of the first transistor S-TFT1 and a second ground GND2 through a current source occurs for sampling and holding an initial image-signal current “I_{data1}” in response to a sample/hold signal “A” and a different conduction path between the drain of the first transistor S-TFT1 and a first ground GND1 through the second transistor D_TFT1 occurs in response to the source of the first transistor S-TFT1 receiving the input image-signal current “I_{data2}” from the pixel circuit 24.

As shown in FIG. 3, the sample/hold signal “A” can be applied to gates of the third, fourth and fifth transistors S/W3, S/W2 and S/W1 of the current sample-and-hold circuit 20 and a signal “B” can be applied to a gate of the sixth transistor S/W6 on the data line 22. In the current sample-and-hold circuit 20 according to the first embodiment of the present invention as shown in FIG. 3, since the hold signal “B” is only applied to the sixth transitory that can be located on the data line outside of the current sample and hold circuit 20, it is possible to reduce the number of signal lines for a current sample and hold circuit by one as compared to the related art current sample-and-hold circuit, in which the hold signal “B” is applied to a transistor within related art current sample-and-hold circuit.

As shown in FIG. 3, the source of the fifth transistor S/W3 is connected to a voltage power supply VDD. The drain of the fifth transistor S/W3 is connected to the source of the first transistor S_TFT1, a first electrode of the capacitor C_{hold} and the drain of the sixth transistor S/W6 on the data line 22. The source of the first transistor S_TFT1 receives an initial image-signal current “I_{data1}” from a voltage power supply VDD and an input image-signal current “I_{data2}” from the pixel circuit 24 via the data line 22. The drain of the first transistor S-TFT1 is connected to the source of the second transistor D-TFT1 and the drain of the fourth transistor S/W2. The second transistor D-TFT1 is connected between the first thin film transistor and a first ground GND1 for sinking the input image-signal current “I_{data2}” from a pixel circuit to the first ground GND1. Further, gates of the first and second transistors S_TFT1 and D_TFT1 are connected in common to a second electrode of the capacitor C_{hold} and the source of the fourth transistor S/W2. The drain of the third transistor S/W1 is connected to a second ground voltage GND2 via a current source and the drain of the second transistor D_TFT1 is connected to the first ground voltage GND1.

FIG. 4 is a diagram illustrating signal waveforms used in the current sample-and-hold circuit shown in FIG. 3. The operation of the current sample-and-hold circuit 20 according to the first embodiment of the present invention will be described in reference to FIG. 3 and FIG. 4. When the sample/hold signal “A” is applied to the current sample-and-hold circuit 20 according to the first embodiment of the present invention, the third, fourth and fifth transistors S/W1, S/W2 and S/W3 are turned on. When the third and fourth transistors S/W1 and S/W2 are turned on, the source and gate of the second transistor D_TFT1 have the same voltage level. As a result, a gate-to-source voltage V_{gs} of the second transistor D_TFT1 becomes “0” such that the second transistor D-TFT1 is turned off.

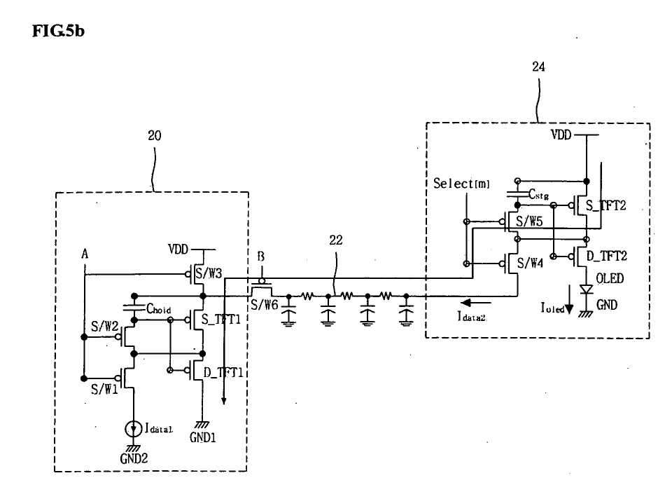

FIGS. 5a and 5b illustrate driving statuses of the current sample-and-hold circuit shown in FIG. 3, which is driven using the signal waveforms shown in FIG. 4. As shown in FIG. 5a, when the sample/hold signal “A” is applied, an initial image-signal current “I_{data1}” flows from the voltage power supply VDD to the third transistor S/W1 by way of the first and fifth transistors S_TFT1 and S/W3, so that an initial image-signal current “I_{data1}” is sampled and held in the capacitor C_{hold}. Referring to FIG. 5b, if the sample/hold signal “A” is removed and the store signal “B” and the select scan signal “select_{[m]}” are applied while the initial image-signal current “I_{data1}” is held in the capacitor C_{hold}, an input image-signal current “I_{data2}” flows from the pixel circuit 24 through the first and second transistors S_TFT1 and D_TFT1 via the sixth transistor S/W6 on the data line 22. At this time, since the V_{gs} of the second transistor D_TFT1 was initially “0,” the second transistor D_TFT1 turns itself on without a signal application to the gate of the second transistor D_TFT1 when the data line is connected to the source of the second transistor D_TFT via the sixth transistor S/W6 on the data line 22. At this time, as the input image-signal current “I_{data2}” flows, data is stored into the storage capacitor C_{stg} of the pixel circuit 24.

In other words, since the second transistor D_TFT1 turns itself off when the sample/hold signal “A” is applied to the third, fourth and fifth transistors S/W1, S/W2 and S/W3 because the gate-to-source voltage V_{gs} of the second transistor D_TFT1 becomes “0”, and is turned on when the signal “B” is applied to the sixth transistor S/W6 such that the data line is connected to the source of the second transistor D_TFT via the sixth transistor S/W6 on the data line 22, an additional signal line to control the second transistor D_TFT1 in the current sample-and-hold circuit 20 in the first embodiment of the present invention is not necessary. Accordingly, the current sample-and-hold circuit 20 according to the first embodiment of the present invention can perform the same functions as the related art current sample-and-hold circuit with smaller number of signal lines. More specifically, a store signal “B” does not need to be applied in the current sample-and-hold circuit of the first embodiment of the present invention.

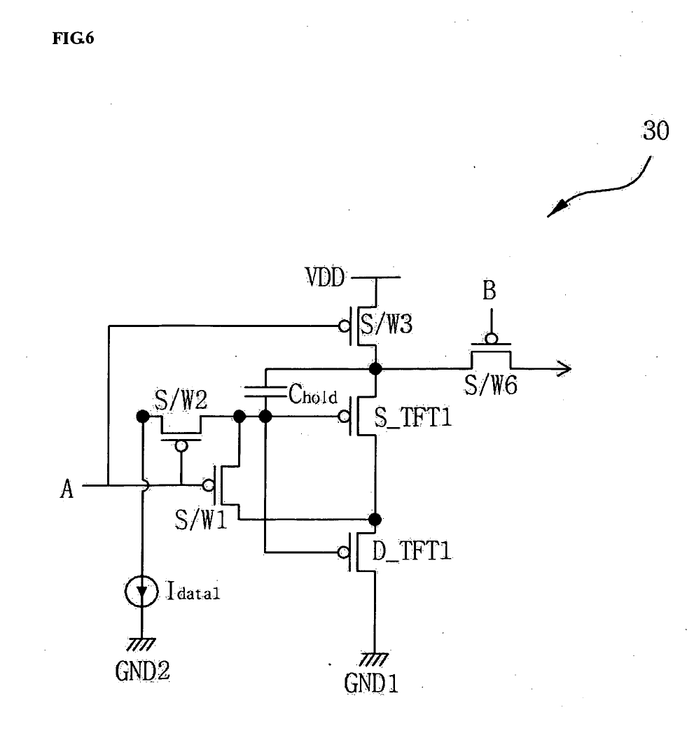

FIG. 6 is a circuit diagram illustrating a current sample-and-hold circuit according to a second embodiment of the present invention. The current sample-and-hold circuit 30 according to the second embodiment of the present invention shown in FIG. 6 is connected to a pixel circuit via a data line, and is similar to the first embodiment of the present invention in that the second embodiment includes a first p-channel transistor S-TFT1, a second p-channel transistor D_TFT1, a third p-channel transistor S/W1, a fourth p-channel transistor S/W2, a fifth p-channel transistor S/W3 and a capacitor C_{hold}. Most of the connections between the transistors and the storage capacitor are the same in the second embodiment as the first embodiment except for the connections of the third and fourth transistors S/W1 and S/W2 in that the source of the fourth transistor S/W2 is connected to the drain of the third transistor S/W1 as well as the second electrode of the storage capacitor C_{hold} and both gates of the first and second transistors S-TFT1 and D_TFT1, the drain of the fourth transistor S/W2 is connected to the first ground via a current source and the drain of the third transistor S/W1 is connected to the source of the second transistor D_TFT1.

Referring to FIGS. 4 and 6, in the current sample-and-hold circuit according to the second embodiment of the present invention, when the sample/hold signal “A” is applied, the third, fourth and fifth transistors S/W1, S/W2 and S/W3 are turned on first. When the third and fourth transistors S/W1 and S/W2 are turned on, the source and gate of the second transistor D_TFT1 have the same voltage level. As a result, a gate-to-source voltage V_{gs} of the second transistor D_TFT1 becomes “0”, such that the second transistor D-TFT1 is turned off.

Similar to the first embodiment, when the sample/hold signal “A” is applied, an initial image-signal current I_{data1} is sampled and held in the capacitor C_{hold} by a current flowing from the power supply VDD to the third transistor S/W1 by way of the first and fifth transistors S_TFT1 and S/W3. If the sample/hold signal “A” is removed and the store signal “B” and the scan signal “select(m)” are applied while the initial image-signal current “I_{data1}” is held in the capacitor C_{hold}, an input image-signal current “I_{data2}” flows from the pixel circuit 24 through the first and second transistors S_TFT1 and D_TFT1 via sixth transistor S/W6 of the data line. At this time, since the V_{gs} of the second transistor D_TFT1 was initially “0,” the second transistors D_TFT1 turns itself on without a signal application to the gate of the second transistor D_TFT1 when the data line is connected to the source of the second transistor D_TFT via the sixth transistor S/W6 on the data line 22. At this time, as the input image-signal current “I_{data2}” flows, data is stored into the storage capacitor of the pixel circuit.

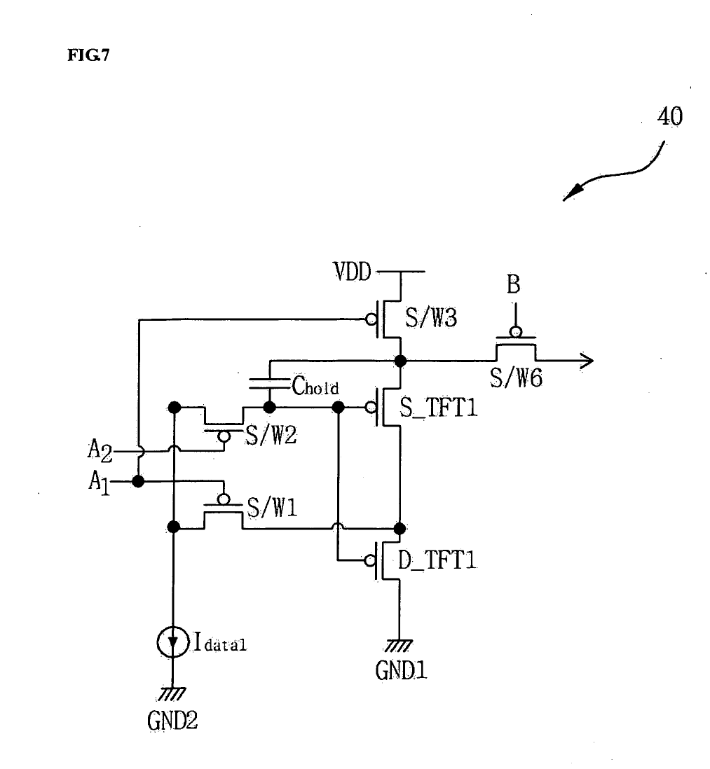

FIG. 7 is a circuit diagram illustrating a current sample-and-hold circuit according to a third embodiment of the present invention. The current sample-and-hold circuit 40 according to the second embodiment of the present invention shown in FIG. 7 is connected to a pixel circuit via a data line, and is similar to the first embodiment of the present invention in that the third embodiment includes a first p-channel transistor S-TFT1, a second p-channel transistor D_TFT1, a third p-channel transistor S/W1, a fourth p-channel transistor S/W2, a fifth p-channel transistor S/W3 and a capacitor C_{hold}. Most of the connections between the transistors and the storage capacitor are the same in the third embodiment as in first embodiment except that the connections of the third and fourth transistors S/W2 and S/W1 are different from the first embodiment and two sample/hold signals are used instead of one sample/hold signal. The source of the third transistor S/W1 is connected to the source of the second transistor D_TFT1, and the source of the fourth transistor S/W2 is connected to the gate of the first transistor S_TFT1 and the gate of the second transistor D_TFT1. Meanwhile, drains of the third and fourth transistors S/W1 and S/W2 are connected to the second ground GND2 via a current source.

In the current sample-and-hold circuit 40 according to the third embodiment of the present invention, the first sample/hold signal “A₁” is applied to the third and fifth transistors S/W1 to S/W3 in common, while a second sample/hold signal “A₂” that is complementary to the first sample/hold signal “A₁” is applied to the second transistor S/W2. Thus, a first sample/hold signal “A₁” can be applied to the gates of third and fifth transistors S/W1 to S/W3 and a second sample/hold signal “A₂” is applied to the second transistor S/W2 such that a gate-to-source voltage V_{gs} of the second transistor D_TFT1 becomes “0” to turn off the second transistor D-TFT1. Even in such a case, an additional control signal for the TFT D_TFT1 is not needed since the second sample/hold signal “A₂” is just a complement of the first sample/hold signal “A₁”.

Referring to FIGS. 4 and 7, in the current sample-and-hold circuit according to the third embodiment of the present invention, in the same way as the first and second embodiments, when the sample/hold signal “A₁” and the second sample/hold signal “A₂” is applied, the third, fourth and fifth transistors S/W1, S/W2 and S/W3 are turned on. When the third and fourth transistors S/W1 and S/W2 are turned on, the source and gate of the second transistor D_TFT1 have the same voltage level. As a result, a gate-to-source voltage V_{gs} of the second transistor D_TFT1 becomes “0”, such that the second transistor D-TFT1 is turned off.

In the embodiments above, one pixel circuit is connected to one current sample-and-hold circuit. In the alternative, one current sample-and-hold circuit can be connected to two or three pixel circuits using a demultiplexer. In an OLED according to the embodiments of the present invention, since a driving unit can be implemented using 1:2 or 1:3 demultiplexers, the number of pins for the data driving unit can be further reduced.

The current sample-and-hold circuit according to the present invention provides at least the following advantages. First, the number of signal lines for controlling the current sample-and-hold circuits can be reduced. Second, decrease of the number of pins for a data driving unit enables the implementation of high resolution OLED display devices. Third, as the numbers of pins and signal lines are reduced, organic light-emitting display devices can be made smaller in size.

It will be apparent to those skilled in the art that various modifications and variations can be made in the current sample-and-hold circuit and display device including the same of the present invention without departing from the spirit or scope of the invention. Thus, it is intended that the present invention cover the modifications and variations of this invention provided they come within the scope of the appended claims and their equivalents.

What is claimed is:

1. A current sample-and-hold circuit, comprising:
a storage capacitor for storing an initial image-signal current;
a first transistor for receiving one of an initial image-signal current from a voltage power supply and an input image-signal current from a pixel circuit;
a second transistor for connecting between the first thin film transistor and a first ground;
a third transistor and a fourth transistor for biasing gates of the first and second transistors to sample and hold the initial image-signal current using a second ground in response to a control signal and sinking the input image-signal current from the pixel circuit to the first ground in response to receiving the input image-signal current from the pixel circuit.

2. The current sample-and-hold circuit according to claim 1, wherein the third transistor has a drain connected to the second ground via a current source, the third transistor has a source connected to both the source of the second transistor and a drain of the fourth transistor, and the fourth transistor has a source connected to an electrode of the capacitor.

3. The current sample-and-hold circuit according to claim 1, wherein the third and fourth transistors have gate commonly connected to each other.

4. The current sample-and-hold circuit according to claim 1, further comprising a fifth transistor for connecting the source of the first transistor to a voltage power supply in response to the control signal.

5. The current sample-and-hold circuit according to claim 4, wherein the third and fifth transistors have gates commonly connected to each other.

6. The current sample-and-hold circuit according to claim 1, wherein the fourth transistor has a source connected to an electrode of the storage capacitor and both gates of the first and second transistors and a drain connected to a source of the third transistor, the third transistor has a drain connected to the first ground via a current source and the third transistor has a drain connected to a source of the second transistor.

7. The current sample-and-hold circuit according to claim 1, wherein the third transistor has a source connected to the source of the second transistor, the fourth transistor has a source connected to the gates of the first and second transistors, and the third and fourth transistors have drains connected in common to the second ground via a current source.

8. A current sample-and-hold circuit, comprising:
a storage capacitor for storing an initial image-signal current;
a first transistor has a source for receiving one of an initial image-signal current from a voltage power supply and an input image-signal current from a pixel circuit, the source of the first transistor connected to a first electrode of the storage capacitor and a gate of the first transistor connected to a second electrode of the capacitor;
a second transistor is connected between the first thin film transistor and a first ground for sinking the input image-signal current from a pixel circuit to the first ground, a gate of the second transistor is connected to the gate of the first transistor;
a third transistor and a fourth transistor for biasing the gates of the first and second transistors such that a first conduction path between the drain of the first transistor and a second ground through a current source occurs for sampling and holding the initial image-signal current in response to a control signal and a second conduction path between the drain of the first transistor and a first ground through the second transistor occurs in response to a source of the first transistor receiving the input image-signal current from the pixel circuit; and
a fifth transistor for connecting the source of the first transistor to a voltage power supply in response to the control signal.

9. The current sample-and-hold circuit according to claim 8, wherein the third transistor has a drain connected to the second ground via the current source, the third transistor has a source connected to both the source of the second transistor and a drain of the fourth transistor, and the fourth transistor has a source connected to the second electrode of the capacitor.

10. The current sample-and-hold circuit according to claim 8, wherein the third and fourth transistors have gates commonly connected to each other.

11. The current sample-and-hold circuit according to claim 8, wherein the third and fifth transistors have gates commonly connected to each other.

12. The current sample-and-hold circuit according to claim 8, wherein the fourth transistor has a source connected to the second electrode of the storage capacitor and both gates of the first and second transistors and a drain connected to a source of the third transistor, the third transistor has a drain connected to the first ground via a current source and a drain of the third transistor is connected to the source of the second transistor.

13. The current sample-and-hold circuit according to claim 8, wherein the third transistor has a source connected to the source of the second transistor, the fourth transistor has a source connected to the gates of the first and second transistors, and the third and fourth transistors have drains connected in common to the second ground via a current source.

14. A display device, comprising:
a pixel circuit positioned at the intersection of a data line and a scan line; and
a current sample-and-hold circuit connected to a voltage power supply, a first ground, a second ground and to the pixel circuit via a data line, the current sample-and-hold circuit including switching means for creating a first conduction path between the voltage power supply and the second ground through a current source to sample and hold an initial image-signal current in response to a control signal and for creating a second conduction path between data line and a first ground through the second transistor in response to receiving an input image-signal current from the pixel circuit via the data line.

15. The display device according to claim 14, wherein the current sample-and-hold circuit includes:
a storage capacitor for storing an initial image-signal current;
a first transistor having a source for receiving one of an initial image-signal current from a voltage power supply and an input image-signal current from a pixel circuit, the source of the first transistor connected to a first electrode of the storage capacitor and a gate of the first transistor connected to a second electrode of the capacitor;
a second transistor is connected between the first thin film transistor and a first ground for sinking the input image-signal current from a pixel circuit to the first ground, a gate of the second transistor is connected to the gate of the first transistor;
a third transistor and a fourth transistor for biasing the gates of the first and second transistors such that an initial image-signal current occurs in the first conduction path in response to a control signal and input image-signal current the pixel circuit occurs in the second conduction path in response to a source of the first transistor receiving the input image-signal current from the pixel circuit.
a fifth transistor for connecting the source of the first transistor to a voltage power supply in response to the control signal.

16. The display device according to claim 15, wherein the third transistor has a drain connected to the second ground via the current source, a source of the third transistor connected to both the source of the second transistor and a drain of the fourth transistor, and the fourth transistor has a source connected to the second electrode of the capacitor.

17. The display device according to claim 15, wherein the third and fourth transistors have gates commonly connected to each other.

18. The display device according to claim 15, wherein the third and fifth transistors have gates commonly connected to each other.

19. The display device according to claim 15, wherein the fourth transistor has a source connected to the drain of the third transistor as well as the second electrode of the storage capacitor and both gates of the first and second transistors, the fourth transistor has a drain connected to the first ground via a current source and a drain of the third transistor is connected to the source of the second transistor.

20. The display device according to claim 15, wherein a the third transistor has a source connected to the source of the second transistor, the fourth transistor has a source connected to the gates of the first and second transistors, and the third and fourth transistors have drains connected in common to the second ground via a current source.
